(19) United States
(12) Patent Application Publication
(10) Pub. No.: US 2026/0291952 A1
(43) Pub. Date: Sep. 24, 2026

(54) CYBERSECURITY DETECTION PRIORITIZATION FOR CYBERSECURITY MANAGEMENT SYSTEMS

(71) Applicant: CrowdStrike, Inc., Sunnyvale, CA (US)

(72) Inventors: Ryan Inghilterra, Carlsbad, CA (US); Joseph Faulhaber, Bozeman, MT (US); Vitaly Zaytsev, Beaverton, OR (US); Michael Brautbar, Groton, MA (US); Manu Nandan, Frisco, TX (US); Brenden Bishop, San Marcos, CA (US); Rakhsha Rashidi, Livermore, CA (US)

(21) Appl. No.: 19/084,338

(22) Filed: Mar. 19, 2025

(51) Int. Cl. H04L 9/40

(52) U.S. Cl. CPC H04L 63/1416

(57) ABSTRACT

The present disclosure provides an approach of obtaining a detection alert comprising a detection feature and corresponding to a computer system. The approach provides the detection alert as an input to an artificial intelligence (AI) model that is trained to produce a class identifier based on the detection feature. The class identifier corresponds to a breach risk of the detection alert to a computer network. The approach computes breach risk prediction score based on the class identifier and a validity ratio, The validity ratio indicates a probability that the detection alert is a true positive alert. In turn, the approach sends an indication of the breach risk prediction score to the computer system.

### TECHNICAL FIELD

Aspects of the present disclosure relate to cybersecurity, and more particularly, to cybersecurity detection prioritization for cybersecurity management systems.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware. Additionally, cybersecurity threats also encompass suspicious activities, such as unusual patterns of network traffic or unauthorized access attempts, which may indicate potential security breaches or weaknesses that need investigation and mitigation.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for training and using an AI model to assign class identifiers (IDs) to new detection alerts and computing a breach prediction score for prioritizing the new detection alerts, in accordance with some embodiments of the present disclosure.

FIG. 2 is a block diagram that illustrates an example system for using an AI model to assign a class ID to new detection alerts for computing a breach prediction score and prioritizing the new detection alerts, in accordance with some embodiments of the present disclosure.

FIG. 3 is a flow diagram of a method 300 for training and using an AI model to assign class identifiers (IDs) to new detection alerts and computing a breach prediction score for prioritizing the new detection alerts, in accordance with some embodiments of the present disclosure.

FIG. 4 is a flow diagram of a method 400 for using an AI model to assign a class to new detection alerts and computing a breach prediction score for prioritizing the new detection alerts, in accordance with some embodiments.

FIG. 5 is a block diagram that illustrates an example system for using an AI model to assign a class to new detection alerts for computing a breach prediction score and prioritizing the new detection alerts, in accordance with some embodiments of the present disclosure.

FIG. 6 is a block diagram of an example computing device that may perform one or more of the operations described herein, in accordance with some embodiments of the present disclosure.

### DETAILED DESCRIPTION

Cybersecurity detections involve the identification and analysis of potential security threats or breaches within a network or system. This process utilizes various technologies and methodologies, such as intrusion detection systems, firewalls, and advanced threat intelligence, to monitor for unusual or unauthorized activities. By analyzing data patterns, network traffic, and user behavior, these systems detect anomalies that may indicate the presence of malware, phishing attempts, or other forms of cyberattacks.

Organizations rely on the detections generated by cybersecurity management systems to safeguard their cyber assets. These systems are used in identifying, monitoring, and responding to potential threats that may compromise the security and integrity of an organization's digital infrastructure. As cyber threats become increasingly sophisticated and pervasive, organizations may adopt a multi-layered defense strategy that involves utilizing multiple security vendors. To effectively manage and analyze the vast amount of data generated by these multiple sources, organizations may employ Security Information and Event Management (SIEM) systems. A SIEM serves as a centralized platform that ingests, correlates, and presents these detections to security analysts for action. SIEM aggregates data from various security tools, including firewalls, intrusion detection systems, and endpoint protection solutions, allowing analysts to gain a comprehensive view of the organization's security posture.

However, the use of multiple vendor solutions also leads to a significant increase in the number and complexity of the detections. This proliferation of alerts can overwhelm security teams, making it challenging to identify which threats require immediate attention. Consequently, enabling analysts to investigate and remediate any potential threat in a timely fashion becomes highly valuable. Efficient threat management not only minimizes the risk of data breaches but also ensures the organization's operations remain uninterrupted.

Existing SIEM solutions largely rely on manual prioritization techniques that are often guided by heuristics developed through the experience and intuition of security analysts, such as analysts checking for detections that match certain criteria or patterns within the SIEM software. For instance, analysts might focus on detections related to specific types of threats, such as malware or unauthorized access attempts, that have been identified as high risk based on past incidents. Another common practice is for analysts to prioritize detections involving their most critical computer assets, such as domain controllers or servers hosting sensitive data. These assets are typically considered high-value targets for attackers, and any detections associated with them may warrant immediate attention.

Manual prioritization approaches, however, have significant drawbacks. First, manual prioritization approaches demand a considerable amount of time and effort from analysts, who sift through numerous detections, conduct preliminary investigations, and determine which alerts merit further scrutiny. This process can be both labor-intensive and mentally taxing, especially given the sheer volume of detections generated by modern security systems. Moreover, manual prioritization approaches introduce a high risk of human error. Analysts might overlook critical detections or misjudge the severity of a threat due to fatigue, cognitive biases, or insufficient information.

In addition, relying on static rule-based systems to prioritize detections can be problematic. These systems might fail to recognize important detections because the rules do not account for emerging threats or new attack vectors. For instance, a novel attack approach might involve activities that were previously deemed low-risk and thus ignored by existing security rules, but which now require urgent attention. Updating the security rules to accommodate new threats is a continuous process that necessitates constant vigilance and adaptation from analysts. This manual maintenance not only consumes valuable time and resources but also leaves room for gaps in coverage if updates are not implemented swiftly.

Risk of breach, also referred to herein as “breach risk,” corresponds the potential likelihood and impact of unauthorized access to a system or network, resulting in the exposure, loss, or theft of sensitive data. This risk is influenced by various factors, including the effectiveness of existing security measures, the value and sensitivity of the data, and the level of threat activity targeting the organization. Likewise, a priority score in cybersecurity is a quantifiable metric used to evaluate the urgency and importance of addressing specific security alerts or detections. The priority score reflects the potential risk and impact of a threat, guiding security teams in prioritizing their response efforts. Priority scores are typically derived from various factors, including the severity of the threat, the likelihood of it being exploited, the sensitivity of the affected systems or data, and the overall risk of a breach occurring if the threat is not mitigated. By providing a clear indication of which issues require immediate attention, a priority score helps optimize resource allocation and enhances the efficiency of security operations.

The present disclosure addresses the above-noted and other deficiencies by using a processing device to obtain a detection alert comprising one or more detection features and corresponding to a computer system. The processing device inputs the detection alert to an artificial intelligence (AI) model that is trained to produce a class identifier based on the detection features. The class identifier corresponds to a breach risk of the detection alert to a computer network. Then, the processing device computes a breach risk prediction score based on the class identifier and a validity ratio. The validity ratio indicates a probability that the detection alert is a true positive alert. In turn, the processing device, in one embodiment, sends an indication of the breach risk prediction score to the computer system. The indication of the breach prediction score is, for example, the breach risk prediction score itself, a remediation instruction corresponding to the breach risk prediction score, a flag, or other identifiers that indicate the breach risk prediction score. In one embodiment, the detection alert is prioritized based on the breach risk prediction score. In one embodiment, the detection alert may be a detection feature about a computer system or a user identity in one or more computer systems. For example, a user login may be flagged for issuing multiple suspicious commands on different computer, each of which alone might not be a detection but, in combination, the detection alert is triggered.

In one embodiment, the processing device labels historical alerts based on features of the historical alerts, and performs statistical analysis on the labeled historical alerts to compute, for each detection feature corresponding to the labeled historical alerts, validity ratios based on whether its corresponding historical alert is determined to be a true positive alert. In turn, the processing device associates each of the alert categories to their corresponding validity ratio.

In one embodiment, to compute the breach risk prediction score, the processing device determines a base value and an upper bound value corresponding to the class identifier, and computes a class range based on the base value and the upper bound value. The processing device obtains a validity ratio corresponding to the detection feature of the detection alert and, in turn, computes the breach risk prediction score using the base value, the class range, and the validity ratio.

In one embodiment, for each one of the historical alerts, the processing device determines a first detection feature condition based on true indicators of the historical alert. The processing device determines a second detection feature condition based on one or more false indications of the historical alert. In turn, the processing device assigns the label to the historical alert based on both the first condition and the second condition.

In one embodiment, the processing device trains the AI model using historical alerts. The processing device labels the historical alerts, based on features corresponding to the historical alerts, to produce labeled historical alerts. The processing device assigns a class identifier to each one of the labeled historical alerts based on their corresponding label. The processing device provides the class historical alerts to the AI model. In one embodiment, the AI model is further trained on alert categories and validity ratios corresponding to the labeled historical alerts. In this embodiment, the AI model produces the breach risk prediction score in response to receiving the detection alert as the input.

As discussed herein, the present disclosure provides an approach that improves the operation of a computer system by efficiently prioritizing detection alerts based on their breach risk prediction scores. This method enables more effective allocation of resources and quicker response times to potential threats, thus enhancing system security. In addition, the present disclosure provides an improvement to the technological field of cybersecurity by leveraging artificial intelligence to accurately predict and rank the risk associated with detection alerts. This approach allows for more precise threat assessment and management, thereby reducing false positives and enhancing the overall reliability and performance of network security systems.

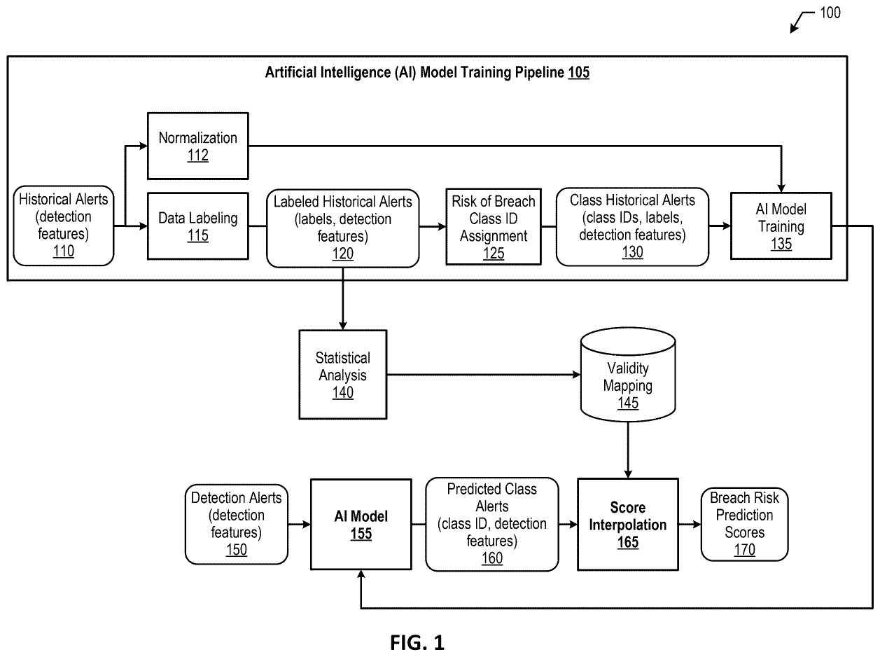

FIG. 1 is a block diagram that illustrates an example system for training and using an AI model to assign class identifiers (IDs) to new detection alerts and computing a breach prediction score for prioritizing the new detection alerts, in accordance with some embodiments of the present disclosure.

System 100 includes artificial intelligence (AI) model training pipeline 105. AI model training pipeline 105 obtains historical alerts 110 from various sources that include corresponding detection features. The detection features may include alert types, pattern dispositions (e.g., how the historical alerts were triaged), or a combination thereof. For example, the pattern dispositions may include one or more of process_blocked, operation_blocked, registry_operation_blocked, operation_downgraded, policy_disabled, critical_process_disabled, kill_action_failed, response_action_failed, or other information about the particular historical alerts.

Historical alerts 110 feed into data labeling 115 where they are labeled based on their corresponding detection features. In one embodiment, data labeling 115 may use a two tier approach to assign labels where the first tier is a true condition and the second tier is a false condition. For the first condition, data labeling 115 determines if one or more detection feature conditions (e.g., C1-C4) are true and, if so, then determines if one or more other detection feature conditions (e.g., C5-C10) are false. Based on the two tier approach, processing logic assigns a label accordingly, such as “no_further_action_needed,” “breach_identified,” “remediated,” “ignored.” More, less, or other labels may be used besides these labels. Data labeling 115 produces labeled historical alerts 120, which feed into risk of breach class assignment 125 and statistical analysis 140.

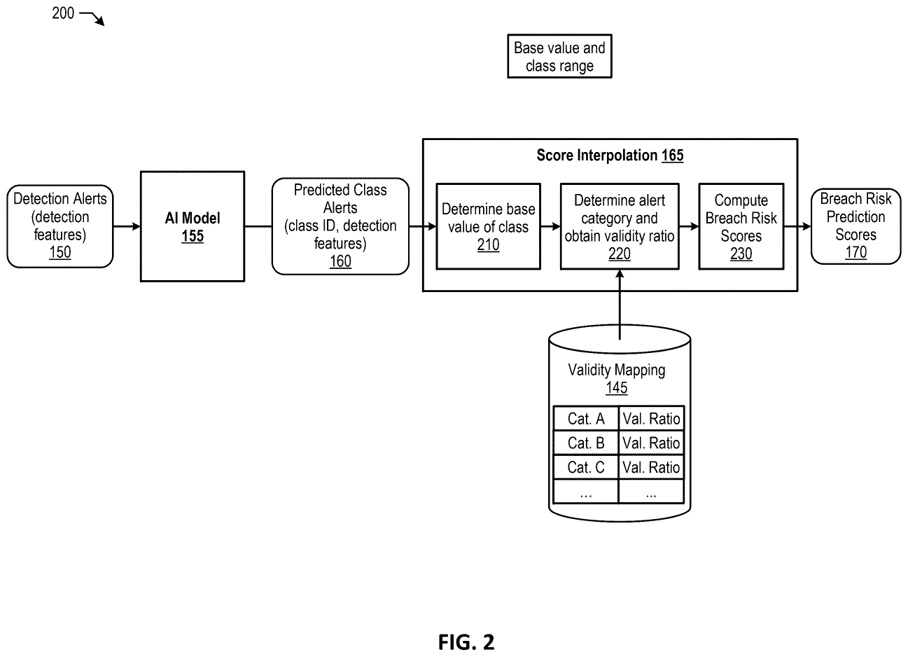

Statistical analysis 140 performs threat inference on labeled historical alerts 120 using the detection features and labels to produce validity ratios for each alert category of labeled historical alerts 120 based on their historical true positive and false positive results. In one embodiment, true positive indicators and false positive indicators are determined from the labels, such as “breach identified” indicates a true positive. In another embodiment, true positive indicators and false positive indicators are included in the detection features. In one embodiment, the alert categories correlate to the detection features. In one embodiment, the alert categories are included in the detection features (e.g., alert types). In turn, statistical analysis 140 produces validity mapping 145, which maps each alert category to a validity ratio (see FIG. 2 and corresponding text for further details).

Referring back to AI model training pipeline 105, risk of breach class ID assignment 125 adds a class identifier to labeled historical alerts 120 based on their corresponding label. For example, “no further action needed” may be assigned “class ID3”; “breach identified” may be assigned “class ID2,” and etcetera. Risk of breach class assignment 125 produces class historical alerts 130, which are then input to AI model training 135 to train AI model 155. Historical alerts 110 are also normalized (via normalization 112), which are also used in AI model training 135.

Once AI model 155 is trained, system 100 inputs new detection alerts 150 into AI model 155. In one embodiment, new detection alerts 150 are normalized. AI model 155 assigns class IDs to new detection alerts 150 based on their corresponding detection features and produces predicted class alerts 160, which feed into score interpolation 165.

Score interpolation 165, in one embodiment, groups predicted class alerts 160 into “buckets” based on their class ID. For example, score interpolation 165 may group class ID0 alerts into one group, class ID1 alerts into another group, etc. Score interpolation 165, in one embodiment, determines a base value and class range for each “bucket” to commence computations. For example, score interpolation 165 may produce scores ranging from 0-100 and segment the range based on the number of class IDs. For example, if there are four class IDs, class 0 may range from 0-25; class 1 ranges from 26-50; class 2 ranges from 51-75; and class 3 ranges from 76-100. In this example, the base value for class ID0 is “0” and the class range is (25−0=25), the base value for class ID1 is “26” and the class range is (50−26=24), etc.

Score interpolation 165 determines a alert category of each new detection alert based on its corresponding detection features, and then obtains a validity ratio from validity mapping 145. Score interpolation 165, in one embodiment, then multiplies the validity ratio to the class range (e.g., .4 validity ratio * 24 class range) and adds the result to the base value to obtain a breach risk prediction score 170 (26+.4*24=35.6) (see FIG. 2 and corresponding text for further details).

In turn, score interpolation 165 sends an indicator of breach risk prediction score 170 to a computer system (e.g., the computer system that experienced the detection alert), which prioritizes new detection alerts 150 based on their corresponding breach risk prediction score 170. In one embodiment system 100 displays breach risk prediction score 170 on a display. In one embodiment, system 100 priorities new detection alerts 150 based on their corresponding breach risk prediction score 170.

FIG. 2 is a block diagram that illustrates an example system for using an AI model to assign a class ID to new detection alerts for computing a breach prediction score and prioritizing the new detection alerts, in accordance with some embodiments of the present disclosure.

System 200 shows an approach of using trained AI model 155 to infer class IDs for new detection alerts 150 that, in turn, are used to interpolate breach risk prediction scores. New detection alerts 150 (e.g., normalized) are input into AI model 155, and AI model 155 assigns a class ID to each of the new detection alerts 150 based on their corresponding detection features to produce predicted class alerts 160. Score interpolation 165 determines a base value corresponding to the class of the new detection alert (210). Using the example above, the range of the breach risk prediction score may be from 0-100 and class ID0 ranges from 0-25; class ID1 ranges from 26-50; class ID2 ranges from 51-75; and class ID3 ranges from 76-100. Using this example, if a new detection alert is a class ID1 alert, score interpolation 165 starts with a base score of 26. Then score interpolation 165 determines an alert category based on the detection features and obtains a corresponding validity ratio from validity mapping 145 (220). Then, score interpolation 165 computes the breach risk prediction score using, in one embodiment, the base value, the validity ratio, and the class range (e.g., 26+.4*24=35.6).

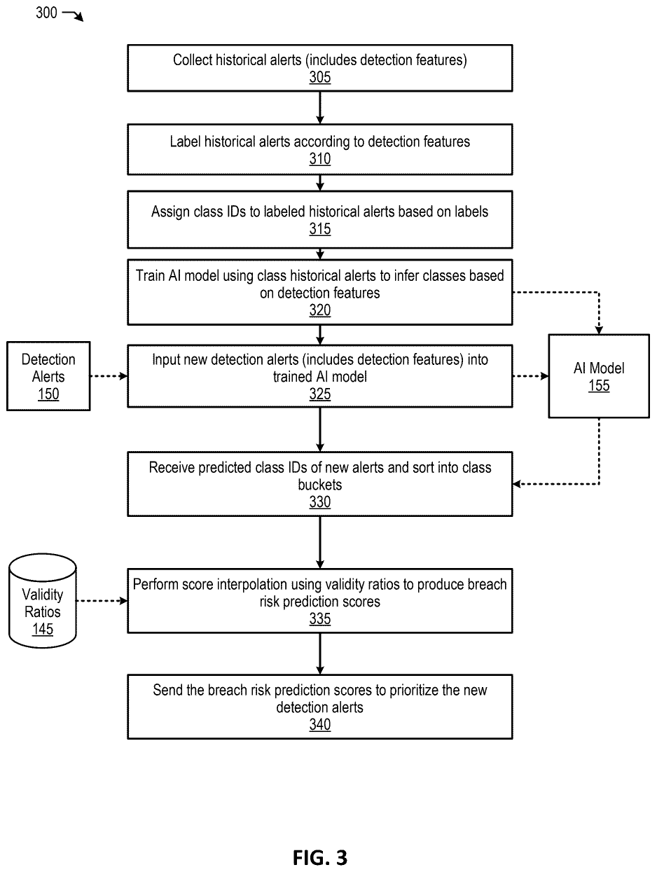

FIG. 3 is a flow diagram of a method 300 for training and using an AI model to assign class identifiers (IDs) to new detection alerts and computing a breach prediction score for prioritizing the new detection alerts, in accordance with some embodiments.

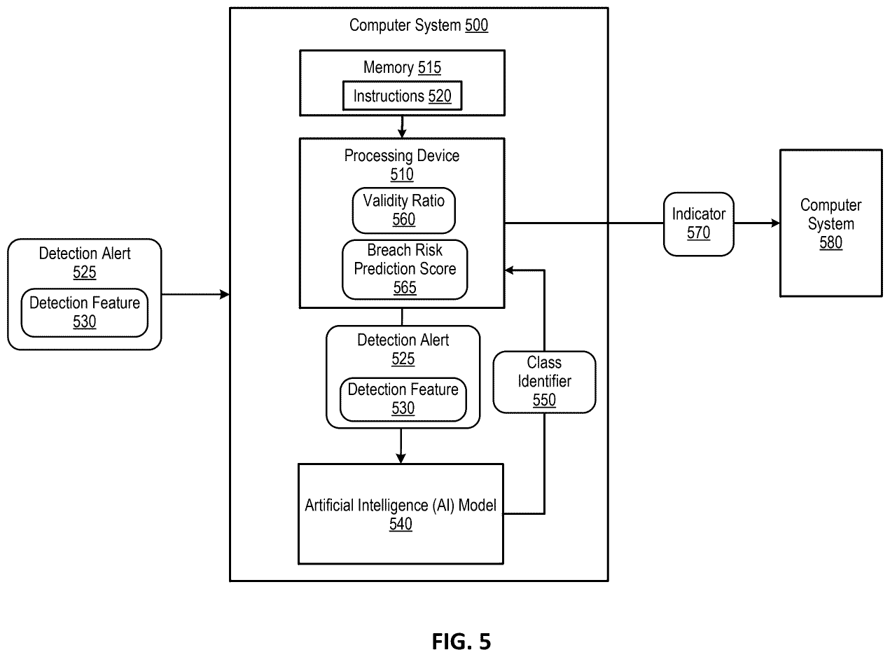

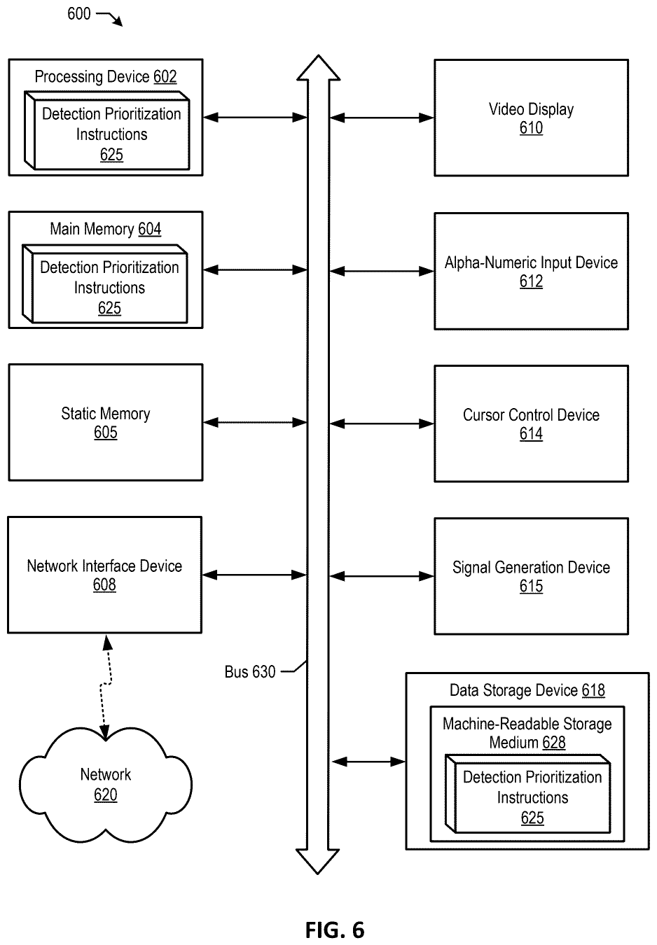

Method 300 may be performed by processing logic that may include hardware (e.g., a processing device), software (e.g., instructions running/executing on a processing device), firmware (e.g., microcode), or a combination thereof. In some embodiments, at least a portion of method 300 may be performed by system 100 (shown in FIG. 1), processing device 510 (shown in FIG. 5), processing device 602 (shown in FIG. 6), or a combination thereof.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 400 may be performed.

With reference to FIG. 3, method 300 begins at block 305, whereupon processing logic collets historical alerts from various sources that include their corresponding detection features. At block 310, processing logic labels the historical alerts according to their detection features. For example, processing logic may use a two tier approach to assign labels where the first tier is a true condition and the second tier is a false condition. For the first condition, processing logic determines if one or more of conditions C1-C4 are true and, if so, then determines if one or more of conditions C5-C10 are false. Based on the two-tier approach, processing logic assigns a label accordingly. In one embodiment, the labels may be “no_further_action_needed,” “breach_identified,” “remediated,” or “ignored.” At block 315, processing logic assigns class IDs to the historical alerts base on the labels. For example, processing logic may use four classes to segment out the historical alerts, such as class ID0 (low breach risk probability) to class ID3 (high breach risk probability).

At block 320, processing logic trains AI model 155 using the class historical alerts to infer class IDs based on the detection features. Once trained, processing logic, at block 325, inputs new detection alerts 150 (e.g., normalized) into AI model 155. At block 330, processing logic receives predicted class IDs of the new detection alerts and, in one embodiment, groups the new detection alerts into “buckets.” For example, processing logic may group the class ID0 alerts into one group, the class ID1 alerts into another group, etc.

At block 335, processing logic performs score interpolation using validity ratios in validity mapping 145 to produce breach risk prediction scores as discussed herein. At block 340, processing logic, in one embodiment, sends the breach risk prediction scores to a computer system corresponding to the new detection alerts (e.g., the computer system that experienced the new detection alerts 150). In one embodiment, the computer system receiving the breach risk prediction scores prioritizes new detection alerts 150 based on their corresponding breach risk prediction scores. In one embodiment, processing logic displays the breach risk prediction scores on a display. In one embodiment, processing logic priorities new detection alerts 150 based on their corresponding breach risk prediction scores. For example, processing logic may prioritize new detection alerts with a score of 90 over the new detection alerts with a score of 70.

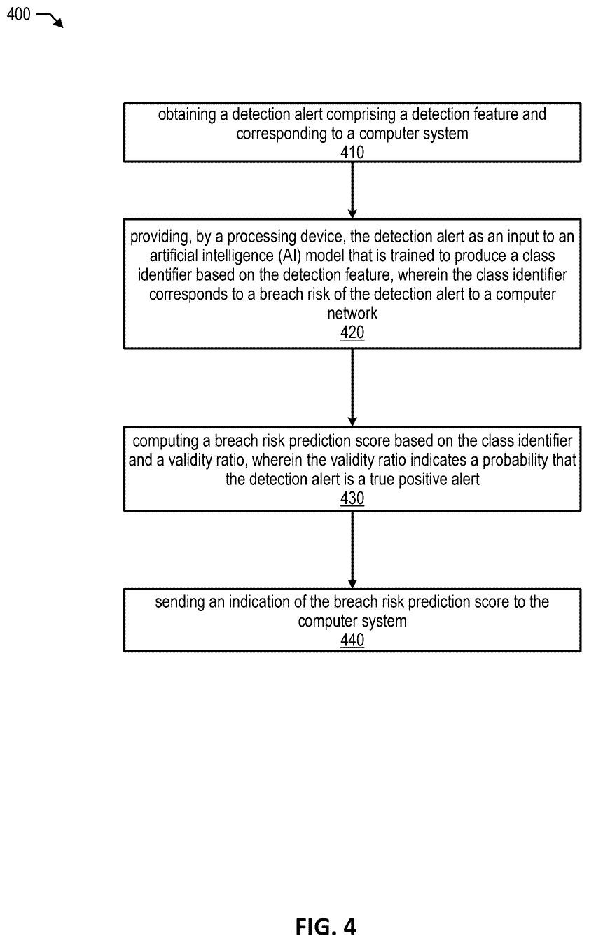

FIG. 4 is a flow diagram of a method 400 for using an AI model to assign a class to new detection alerts and computing a breach prediction score for prioritizing the new detection alerts, in accordance with some embodiments.

Method 400 may be performed by processing logic that may include hardware (e.g., a processing device), software (e.g., instructions running/executing on a processing device), firmware (e.g., microcode), or a combination thereof. In some embodiments, at least a portion of method 400 may be performed by system 200 (shown in FIG. 2), processing device 510 (shown in FIG. 5), processing device 602 (shown in FIG. 6), or a combination thereof.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, whereupon processing logic obtains a detection alert comprising one or more detection features and corresponding to a computer system. At block 420, processing logic provides the detection alert as an input to an artificial intelligence (AI) model that is trained to produce a class ID based on the one or more detection features. The class ID corresponds to a breach risk of the detection alert to a computer network.

At block 430, processing logic computes a breach risk prediction score based on the class ID and a validity ratio. The validity ratio indicates a probability that the detection alert is a true positive alert. In one embodiment, to compute the breach risk prediction score, processing logic determines a base value and an upper bound value corresponding to the class ID, and computes a class range based on the base value and the upper bound value. Processing logic then obtains a validity ratio corresponding to a detection category (determined by the detection feature) and, in turn, computes the breach risk prediction score using the base value, the class range, and the validity ratio as discussed herein.

At block 440, processing logic, in one embodiment, sends an indication of the breach risk prediction score to the computer system. The indication of the breach prediction score is, for example, the breach risk prediction score itself, a remediation instruction corresponding to the breach risk prediction score, a flag, or other identifiers that indicate the breach risk prediction score.

FIG. 5 is a block diagram that illustrates an example system for using an AI model to assign a class to new detection alerts for computing a breach prediction score and prioritizing the new detection alerts, in accordance with some embodiments of the present disclosure.

Computer system 500 includes processing device 510 and memory 515. Memory 515 stores instructions 520 that are executed by processing device 510. Instructions 520, when executed by processing device 510, cause processing device 510 to obtain detection alert 525 that, in one embodiment, includes detection feature 530 and corresponds to computer system 580. Processing device 510 provides detection alert 525 as an input to artificial intelligence (AI) model 540, which is trained to produce a class identifier 550 corresponding to a breach risk to a computer network based on the detection feature 530. Processing device 510 computes a breach risk prediction score 565 based on the class identifier 550 and a validity ratio 560, which indicates a probability that the detection alert 525 is a true positive alert. In turn, processing device 510 sends indicator 570 to computer system 580, which indicates the breach risk prediction score 565.

FIG. 6 illustrates a diagrammatic representation of a machine in the example form of a computer system 600 within which a set of instructions, for causing the machine to perform any one or more of the methodologies discussed herein for training and using an AI model to assign a class to new detection alerts for computing a breach prediction score and prioritizing the new detection alerts.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute detection prioritization instructions 625, for performing the operations and steps discussed herein.

The data storage device 618 may include a machine-readable storage medium 628, on which is stored one or more sets of detection prioritization instructions 625 (e.g., software) embodying any one or more of the methodologies of functions described herein. The detection prioritization instructions 625 may also reside, completely or at least partially, within the main memory 604 or within the processing device 602 during execution thereof by the computer system 600; the main memory 604 and the processing device 602 also constituting machine-readable storage media. The detection prioritization instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “obtaining,” “providing,” “computing,” “prioritizing,” “labeling,” “performing,” “associating,” “determining,” “training,” “inputting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
obtaining a detection alert comprising a detection feature and corresponding to a computer system;
providing, by a processing device, the detection alert as an input to an artificial intelligence (AI) model that is trained to produce a class identifier based on the detection feature, wherein the class identifier corresponds to a breach risk of the detection alert to a computer network;
computing a breach risk prediction score based on the class identifier and a validity ratio, wherein the validity ratio indicates a probability that the detection alert is a true positive alert; and
sending an indication of the breach risk prediction score to the computer system.

2. The method of claim 1, further comprising:
labeling a plurality of historical alerts, based on a plurality of detection features corresponding to the plurality of historical alerts, to produce a plurality of labeled historical alerts;
performing statistical analysis on the plurality of labeled historical alerts to compute, for each one of a plurality of alert categories corresponding to the plurality of labeled historical alerts, one of a plurality of validity ratios based on whether its corresponding historical alert is indicated to be a true positive alert; and
associating each one of the plurality of alert categories to their corresponding one of the plurality of validity ratios.

3. The method of claim 2, further comprising:
determining a base value and an upper bound value corresponding to the class identifier;
computing a class range based on the base value and the upper bound value;
obtaining a validity ratio, from the plurality of validity ratios, corresponding to the detection feature of the detection alert; and
computing the breach risk prediction score using the base value, the class range, and the validity ratio.

4. The method of claim 2, wherein the labeling further comprises:
for each one of the plurality of historical alerts:
determining a first detection feature condition based on one or more true indications of the historical alert;
determining a second detection feature condition based on one or more false indications of the historical alert; and
assigning the label to the historical alert based on both the first detection feature condition and the second detection feature condition.

5. The method of claim 1, wherein, prior to the obtaining the detection alert, the method comprises:
training the AI model, the training comprising:
labeling a plurality of historical alerts, based on a plurality of detection features corresponding to the plurality of historical alerts, to produce a plurality of labeled historical alerts;
assigning a class identifier to each one of the plurality of labeled historical alerts based on their corresponding label to produce a plurality of class historical alerts; and
inputting the plurality of class historical alerts to the AI model.

6. The method of claim 5, wherein
the AI model is further trained on a plurality of alert categories and a plurality of validity ratios corresponding to the plurality of labeled historical alerts; and
the further trained AI model produces the breach risk prediction score in response to receiving the detection alert.

7. The method of claim 1, wherein the detection alert is prioritized based on the breach risk prediction score.

8. A system comprising:
a memory; and
a processing device, that is operatively coupled to the memory, to:
obtain a detection alert comprising a detection feature and corresponding to a computer system;
provide the detection alert as an input to an artificial intelligence (AI) model that is trained to produce a class identifier based on the detection feature, wherein the class identifier corresponds to a breach risk of the detection alert to a computer network;
compute a breach risk prediction score based on the class identifier and a validity ratio, wherein the validity ratio indicates a probability that the detection alert is a true positive alert; and
send an indication of the breach risk prediction score to the computer system.

9. The system of claim 8, wherein the processing device is further to:
label a plurality of historical alerts, based on a plurality of detection features corresponding to the plurality of historical alerts, to produce a plurality of labeled historical alerts;
perform statistical analysis on the plurality of labeled historical alerts to compute, for each one of a plurality of alert categories corresponding to the plurality of labeled historical alerts, one of a plurality of validity ratios based on whether its corresponding historical alert is indicated to be a true positive alert; and
associate each one of the plurality of alert categories to their corresponding one of the plurality of validity ratios.

10. The system of claim 9, wherein the processing device is further to:
determine a base value and an upper bound value corresponding to the class identifier;
compute a class range based on the base value and the upper bound value;
obtain a validity ratio, from the plurality of validity ratios, corresponding to the detection feature of the detection alert; and
compute the breach risk prediction score using the base value, the class range, and the validity ratio.

11. The system of claim 9, wherein the processing device is further to:
for each one of the plurality of historical alerts:
determine a first detection feature condition based on one or more true indications of the historical alert;
determine a second detection feature condition based on one or more false indications of the historical alert; and
assign the label to the historical alert based on both the first detection feature condition and the second detection feature condition.

12. The system of claim 8, wherein the processing device is further to:
train the AI model, the training comprising:
label a plurality of historical alerts, based on a plurality of detection features corresponding to the plurality of historical alerts, to produce a plurality of labeled historical alerts;
assign a class identifier to each one of the plurality of labeled historical alerts based on their corresponding label to produce a plurality of class historical alerts; and
input the plurality of class historical alerts to the AI model.

13. The system of claim 12, wherein
the AI model is further trained on a plurality of alert categories and a plurality of validity ratios corresponding to the plurality of labeled historical alerts; and
the further trained AI model produces the breach risk prediction score in response to receiving the detection alert.

14. The system of claim 12, wherein the detection alert is prioritized based on the breach risk prediction score.

15. A non-transitory computer readable medium, storing instructions that, when executed by a processing device, cause the processing device to:
obtain a detection alert comprising a detection feature and corresponding to a computer system;
provide, by the processing device, the detection alert as an input to an artificial intelligence (AI) model that is trained to produce a class identifier based on the detection feature, wherein the class identifier corresponds to a breach risk of the detection alert to a computer network;
compute a breach risk prediction score based on the class identifier and a validity ratio, wherein the validity ratio indicates a probability that the detection alert is a true positive alert; and
send an indication of the breach risk prediction score to the computer system.

16. The non-transitory computer readable medium of claim 15, wherein the processing device is to:
label a plurality of historical alerts, based on a plurality of detection features corresponding to the plurality of historical alerts, to produce a plurality of labeled historical alerts;
perform statistical analysis on the plurality of labeled historical alerts to compute, for each one of a plurality of alert categories corresponding to the plurality of labeled historical alerts, one of a plurality of validity ratios based on whether its corresponding historical alert is indicated to be a true positive alert; and
associate each one of the plurality of alert categories to their corresponding one of the plurality of validity ratios.

17. The non-transitory computer readable medium of claim 16, wherein the processing device is further to:
determine a base value and an upper bound value corresponding to the class identifier;
compute a class range based on the base value and the upper bound value;
obtain a validity ratio, from the plurality of validity ratios, corresponding to the detection feature of the detection alert; and
compute the breach risk prediction score using the base value, the class range, and the validity ratio.

18. The non-transitory computer readable medium of claim 16, wherein the processing device is further to:
for each one of the plurality of historical alerts:
determine a first detection feature condition based on one or more true indications of the historical alert;
determine a second detection feature condition based on one or more false indications of the historical alert; and
assign the label to the historical alert based on both the first detection feature condition and the second detection feature condition.

19. The non-transitory computer readable medium of claim 15, wherein the processing device is further to:
train the AI model, the training comprising:
label a plurality of historical alerts, based on a plurality of detection features corresponding to the plurality of historical alerts, to produce a plurality of labeled historical alerts;
assign a class identifier to each one of the plurality of labeled historical alerts based on their corresponding label to produce a plurality of class historical alerts; and
input the plurality of class historical alerts to the AI model.

20. The non-transitory computer readable medium of claim 19, wherein the detection alert is prioritized based on the breach risk prediction score.
